(19) United States
(12) Patent Application Publication
(10) Pub. No.: US 2012/0081331 A1
(43) Pub. Date: Apr. 5, 2012

(54) TOUCH SCREEN

(75) Inventors: Kyoung Soo Chae, Seoul (KR); Hee Bum Lee, Gyunggi-do (KR); Yong Soo Oh, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 13/166,558

(22) Filed: Jun. 22, 2011

(30) Foreign Application Priority Data
Sep. 30, 2010 (KR) 102010095008

(51) Int. Cl. G06F 3/044

(52) U.S. Cl. 345/174

(57) ABSTRACT

Disclosed herein is a touch screen. The touch screen includes: a transparent substrate; and transparent electrodes formed on the transparent substrate and sensing a change in capacitance at the time of a touch input, wherein the transparent electrodes include internal transparent electrodes and external transparent electrodes, and the internal transparent electrodes include first sensing units sensing the change in capacitance, extending portions extending to edges of the transparent substrate from the first sensing units, and the extending portions of the adjacent internal transparent electrodes face each other, whereby the extending portions face each other to reduce the frequency of the coordinate errors of the touch input corrected in the controller.

### CROSS REFERENCE TO RELATED APPLICATION

This application claims the benefit of Korean Patent Application No. 10-2010-0095008, filed on Sep. 30, 2010, entitled “Touch Screen,” which is hereby incorporated by reference in its entirety into this application.

### BACKGROUND OF THE INVENTION

1. Technical Field

The present invention relates to a touch screen.

2. Description of the Related Art

With the continuous development of electronic technology and information technology fields, the relative importance of electronic devices is constantly increasing in everyday life, including work environments. In particular, as an electronic technology is continuously developed, touch screens have been used in portable devices that are being recently reduced in size and thickness.

Touch screens are devices that are installed in display devices to sense positions on the screen which a user touches and control electronic devices, in addition to controlling pictures on the display, by using information on the sensed touch position as input information. The touch screens have various advantages of being simply operated with minimal malfunction in a small space and very compatible with IT devices.

Meanwhile, the touch screen can be classified into a resistive type, a capacitive type, an electromagnetic type, a surface acoustic wave (SAW) type, an infrared type, and so on. Among others, the resistive and capacitive types are prevalently used in consideration of the functions and economic reasons. Recently, research into the capacitive touch screen having excellent touch sense, durability, and multi-touch performance has been mainly conducted.

The capacitive touch screen according to the prior art is classified into a self capacitance type touch screen and a mutual capacitance type touch screen.

In this case, the self capacitance type touch screen obtains coordinates of touch inputs by a scheme using a single sensing unit per basic unit for touch recognition to read a change in capacitance of the sensing units. Therefore, unlike the mutual capacitance type, the self capacitance type touch screen requires only a single layer composed of transparent electrodes including the sensing units and has coordinate information per sensing unit sensing the change in capacitance.

In this case, each sensing unit of the transparent electrodes is electrically isolated from each other, such that electrodes should be connected to each sensing unit. In this case, the transparent electrodes formed at the outer side may be directly connected to electrodes formed at edges of a transparent substrate, but the transparent electrodes formed at an inner side extend between the transparent electrodes formed at the outer side, so as to connect to the electrodes.

However, since the touch screen according to the prior art has a problem of causing errors at the time of the touch input due a portion extending from the internal transparent electrodes. In detail, when the portions extending from the internal transparent electrodes are disposed between the external transparent electrodes and the touch inputs are applied to the external transparent electrodes, the portions are touched together with the external transparent electrodes, thereby causing a problem of being erroneously recognized as the state where the internal transparent electrodes are touched.

### SUMMARY OF THE INVENTION

The present invention has been made in an effort to provide a touch screen capable of reducing a frequency of a coordinate recognition error of touch inputs due to the extending portions of the internal transparent electrodes in a self capacitance type touch screen.

A touch screen according to a preferred embodiment of the present invention includes: a transparent substrate; and transparent electrodes formed on the transparent substrate and sensing a change in capacitance at the time of a touch input, wherein the transparent electrodes include internal transparent electrodes and external transparent electrodes, and the internal transparent electrodes include first sensing units sensing the change in capacitance, extending portions extending to edges of the transparent substrate from the sensing units, and the extending portions of the adjacent internal transparent electrodes face each other.

The touch screen may further include: an adhesive layer formed on the transparent substrate on which the transparent electrodes are formed; and a window panel bonded to the transparent substrate through the adhesive layer.

The external transparent electrodes may further include second sensing units sensing a change in capacitance.

The transparent electrodes may be made of a conductive polymer.

The touch screen may further include first electrodes formed at edges of the transparent substrate and connected to the extending portions of the internal transparent electrodes.

The touch screen may further include second electrodes formed at edges of the transparent substrate and connected to the external transparent electrodes.

The extending portions of the internal transparent electrodes may extend between the external transparent electrodes.

### BRIEF DESCRIPTION OF THE DRAWINGS

FIG. 1 is a plan view of a touch screen according to a preferred embodiment of the present invention;

FIG. 2 is a cross-sectional view of the touch screen shown in FIG. 1; and

FIGS. 3 and 4 are diagrams for explaining signal correction of the touch screen shown in FIG. 1.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. In describing the present invention, a detailed description of related known functions or configurations will be omitted so as not to obscure the gist of the present invention.

Meanwhile, in the use of terms in the present invention, “contact input” means both “contact” and “approximation”. “Contact” means the case being completely contacted, and “approximation” means the case being very close even though not being completely contacted.

Hereinafter, preferred embodiments of the present invention will be described in detail with reference to the accompanying drawings.

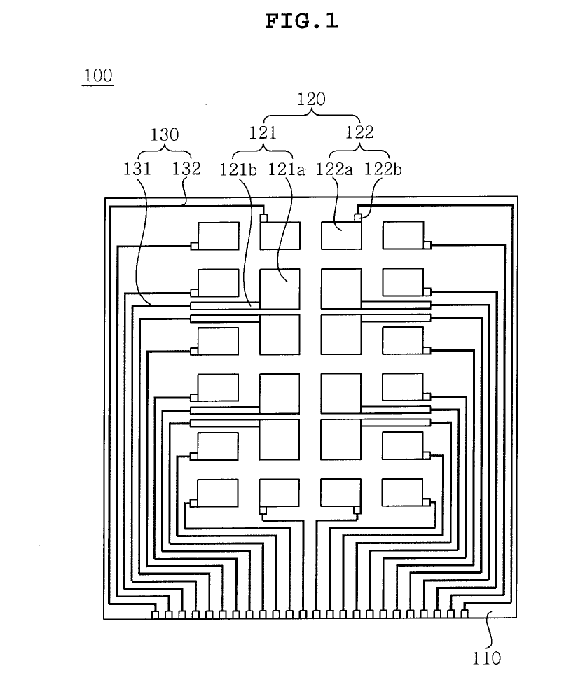

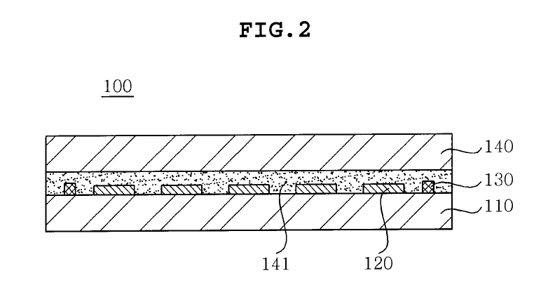

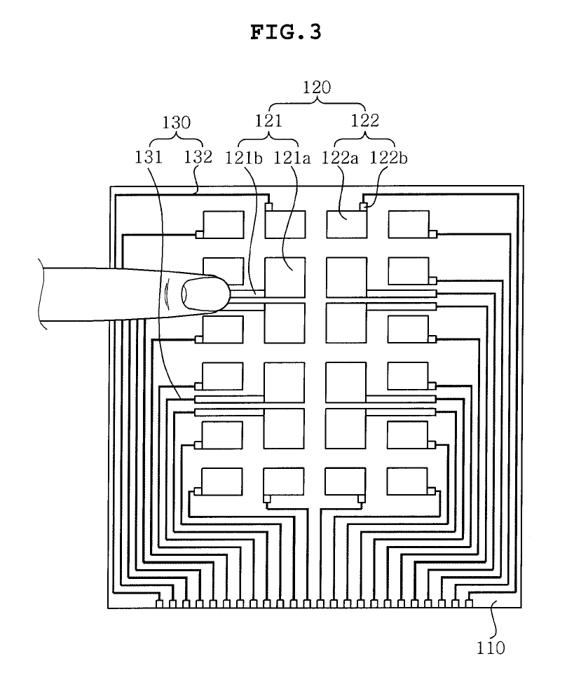

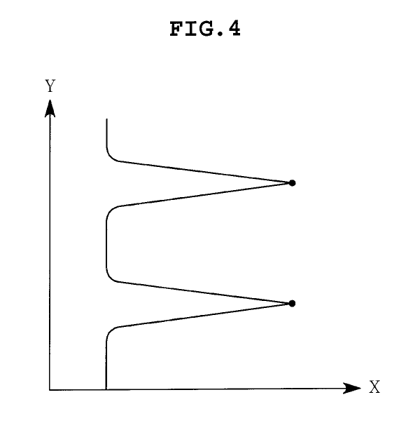

FIG. 1 is a plan view of a touch screen 100 according to a preferred embodiment of the present invention, FIG. 2 is a cross-sectional view of the touch screen 100 shown FIG. 1, and FIGS. 3 and 4 are diagrams for explaining signal correction of the touch screen 100 shown in FIG. 1. Hereinafter, the touch screen 100 according to the present preferred embodiment will be described with reference to the accompanying drawings.

In this configuration, FIG. 1 shows a case where a window panel 140 and an adhesive layer 141 are omitted, but is for convenience of explanation. It is to be noted that the touch screen 100 of the present invention many include the window panel 140 and the adhesive layer 141.

As shown in FIGS. 1 and 2, the touch screen 100 according to the present preferred embodiment includes a transparent substrate 110, transparent electrodes 120, electrodes 130, and a window panel 140.

The transparent substrate 110, which is a member in which spaces formed with the transparent electrodes 120 are provided, serves as a base of the touch screen 100.

In this configuration, the transparent substrate 110 may be made of a transparent material so that an image from a display (not shown) installed on the lower portion of the touch screen 100 can be clearly transferred to a user. The transparent substrate 110 may, for example, be made of polyethyleneterephthalate (PET), polycarbonate (PC), polymethylmethacrylate (PMMA), polyethylenenaphthalene (PEN), polyethersulfone (PES) or cyclic olefin copolymer (COC). Besides, glass or tempered glass may be generally used.

In addition, the transparent electrodes 120 are formed on one surface of the transparent substrate 110, such that it is preferable to perform a high-frequency treatment or a primer treatment thereon in order to improve the adhesion with the transparent electrodes 120.

The transparent electrodes 120 are a member that is formed on one surface of the transparent substrate 110 to sense the change in capacitance at the time of contact input.

Herein, the transparent electrodes 120 sense a change in capacitance from the touched input of a specific object, such as the user's body or a stylus pen, and transmits the changes to a controller (not shown), and then the controller (not shown) recognizes the coordinates of the pushed position, thereby implementing desired operations. More specifically, when high frequency is diffused throughout the transparent electrodes 120 by applying voltage through the electrodes 130 and the touched inputs are then applied by a human body etc., a predetermined change occurs in capacitance while the transparent electrodes 120 serve as electrodes and the window panel 140 and/or the adhesive layer 141 serve as dielectrics, and the controller (not shown) can recognize the positions of the touched inputs or whether the touched inputs are generated by sensing the changed waveform.

Meanwhile, the transparent electrodes 120 may be made of a conductive material so as to sense the change in capacitance. Further, since the transparent electrodes 120 are patterned over the transparent substrate 110, it may be made of a transparent material. The transparent electrodes 120 may, for example, be made of conductive polymer containing poly-3,4-ethylenedioxythiophene/polystyrenesulfonate (PEDOT/PSS), polyaniline alone or a mixture thereof, or metal oxides, such as indium tin oxide (ITO). In this case, when the transparent electrodes 120 are made of a metal oxide, it may be coated on the transparent substrate 110 by deposition, development, etching, etc. and when the transparent electrodes 120 are made of a conductive polymer, it may be formed on the transparent substrate 110 by a silk screen printing method, an inkjet printing method, a gravure printing method, an offset printing method, or the like.

Further, the touch screen 100 according to the present invention obtains the coordinates of the touched inputs by the self capacitance type, among the capacitive touch screens. Therefore, each electrode 130 is connected to each sensing unit 121a and 122a of the transparent electrodes 120 and the coordinate information may be obtained for each sensing unit 121a and 122a. In this case, FIG. 3 shows the case where the sensing units 121a and 122a have a quadrangular pattern, but the present invention is not limited thereto. The shape of the sensing units 121a and 122a may be variously implemented as a polygonal shape, a circular shape, and an oval shape, such as a diamond, a triangle, a hexagon, or the like.

Meanwhile, the transparent electrodes 120 may include the internal transparent electrodes 121 and the external transparent electrodes 122. In this case, the “external transparent electrode 122” implies that the transparent electrodes 120 are formed at the outermost side in all columns and rows of the transparent electrodes 120 and the “internal transparent electrode 121”, which is formed in the inner side among the transparent electrodes 120, implies the remaining transparent electrodes other than the external transparent electrodes 122.

In this case, since the internal transparent electrodes 121 are connected to the first electrodes 131 at the edges of the transparent substrate 110 through the spaces between the external transparent electrodes 122, it may include extending portions 121b extending from the first sensing units 121a through the spaces between the external transparent electrodes 122 and the first sensing units 121a sensing the change in capacitance. In this case, in a group of the adjacent internal transparent electrodes 121, the extending portions 121b may be formed to face each other. Herein, “facing” implies that the extending portions 121b of the adjacent two internal transparent electrodes 121 extend in the same space, among the spaces between the external transparent electrodes 122.

In addition, the external transparent electrodes 122 are a portion that can directly be connected to the electrodes 130 at the edge portions of the transparent substrate 110 and may include second sensing units 122a sensing the change in capacitance at the time of a touch input. In addition, in order to electrically connect the external transparent electrodes 122 to the second electrodes 132, the second sensing units 122a may be provided at the protruding portion 122b and the protruding portion 122b may be connected to the second electrodes 132.

Meanwhile, the size of the first sensing unit 121a may be larger by height of the extending portion 121b than that of the second sensing units 122a so that the extending portions 121b extending from the first sensing units 121a of the internal transparent electrodes 121 may be positioned in the spaces between the external transparent electrodes 122.

The signal correction of the touch screen 100 will be described below with reference to FIGS. 3 and 4.

As shown in FIG. 3, for example, when the user applies the touch input to the external transparent electrodes 122, the user's fingers may contact the extending portions 121b of the internal transparent electrodes 121. In this case, since the extending portions 121b are connected to the first sensing units 121a of the internal transparent electrodes 121, the touch screen 100 may erroneously recognize that the internal transparent electrodes 121 is touched, even when the user touches the surrounding area of the external transparent electrodes 122. In particular, when the touch input is dragged along the vertical line of the external transparent electrodes 122, FIG. 4 can appreciate the phenomenon (error) that the signals of the touch input coordinates form a predetermined vertical line and are then bounced off once. The extending portions 121b between the external transparent electrodes 122 are touched while being touched along the vertical line of the external transparent electrodes 122, such that the error phenomenon recognized as the situation where the inner side is touched even when the outer side of the touch screen is touched may occur.

Therefore, in order to solve the problems, the touch screen 100 may include the controller (not shown) performing the correction for coordinates when the extending portions 121b are touched, wherein the controller (not shown) can recognize the points actually touched by the user by correcting the coordinates of the touch input.

Meanwhile, when the controller (not shown) performs the correction of the coordinates, the complicated arithmetic process should be performed at the actually touched position, in consideration of the relationship with the adjacent external transparent electrodes 122, etc. When too many errors occur at the time of recognizing the coordinates of the touch inputs, data to be processed in the controller (not shown) are increased, such that there is a problem in implementing feedback during a relatively long time after the touch input is applied. That is, after the touch input is applied, there is a problem in that the touch screen 100 may be recognized by correcting erroneous coordinates after, for example, 3 to 4 seconds.

However, as in the present invention, when the extending portions 121b of the adjacent internal transparent electrodes 121 face each other, the occurrence frequency of the coordinate recognition errors of the touch inputs may be reduced to half, as compared to when the extending portions 121b of the adjacent internal transparent electrodes 121 does not face each other. For example, as in the touch screen 100 shown in FIG. 3, when the transparent electrodes 120 have a pattern of 6 rows and 4 columns, the external transparent electrodes 122 are dragged along a vertical line, the occurrence points of the recognition error at the touched positions may be generated only twice as shown in FIG. 4. On the other hand, when the extending portion 121b extends to the spaces between difference external transparent electrodes 122, that is, when the extending portions of the adjacent internal transparent electrodes 121 do not face each other, the recognition error may occur four times.

As a result, when the extending portions 121b face each other, the recognition error occurrence is reduced to half, as compared to when the extending portions 121b do not face each other, such that data to be processed by the controller (not shown) performing the correction of the coordinates may be reduced and the touch screen 100 rapidly performing the implementation of the feedback may be manufactured.

The electrode 130 is a member that is formed on the edges of the transparent substrate 110 to apply voltage to the transparent electrodes 120.

In this configuration, the electrodes 130 may include the first electrodes 131 connected to the extending portion 121b of the internal transparent electrodes 121 and the second electrodes 132 connected to the external transparent electrodes 122. In addition, the electrodes 130 may be made of a material having excellent electrical conductivity so as to supply voltage to the transparent electrodes 120. For example, the electrodes 130 may be made of a material composed of silver (Ag) paste or organic silver. Further, in order to reduce a bezel area, the electrodes 130 may be made of a transparent material, such as a conductive polymer or a metal oxide, similar to the transparent electrodes 120.

The window panel 140 is a member that is formed on one surface of the transparent substrate 110 on which the transparent electrodes 120 are formed to protect other components of the touch screen 100.

Herein, the window panel 140, which is a portion receiving the touch input from a specific object, such as a user's body or a stylus pen, etc., maintains the external appearance the input portion of the touch screen 100. Therefore, it is preferable that the window panel 140 is made of a transparent material for a user to be able to see a display well, having large durability so as to sufficiently protect the touch screen 100 from the external force, for example, polyethylene terephthalate (PET) or glass.

Meanwhile, the adhesive layer 141 may be formed between the window panel 140 and the transparent substrate 110 so as to fix the window panel 140 and the transparent substrate 110. At this time, the adhesive layer 141 is formed on the entire surface between the window panel 140 and the transparent substrate 110. The adhesive layer 141 may be formed of, for example, an optical clear adhesive (OCA).

In the touch screen according to the present invention, the controller corrects the errors of the touched input coordinates due to the extending portions of the internal transparent electrodes and disposes the extending portions of the adjacent internal transparent electrodes to face each other, such that it can reduce the error occurrence frequency of the touched input coordinates to be corrected.

Although the preferred embodiments of the present invention have been disclosed for illustrative purposes, they are for specifically explaining the present invention and thus a touch screen according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A touch screen, comprising:
a transparent substrate; and
transparent electrodes formed on the transparent substrate and sensing a change in capacitance at the time of a touch input,
wherein the transparent electrodes include internal transparent electrodes and external transparent electrodes, and the internal transparent electrodes include first sensing units sensing the change in capacitance, extending portions extending to edges of the transparent substrate from the first sensing units, and the extending portions of the adjacent internal transparent electrodes face each other.

2. The touch screen as set forth in claim 1, further comprising:
an adhesive layer formed on the transparent substrate on which the transparent electrodes are formed; and
a window panel bonded to the transparent substrate through the adhesive layer.

3. The touch screen as set forth in claim 1, wherein the external transparent electrodes further include second sensing units sensing a change in capacitance.

4. The touch screen as set forth in claim 1, wherein the transparent electrodes are made of a conductive polymer.

5. The touch screen as set forth in claim 1, further comprising first electrodes formed at edges of the transparent substrate and connected to the extending portions of the internal transparent electrodes.

6. The touch screen as set forth in claim 1, further comprising second electrodes formed at edges of the transparent substrate and connected to the external transparent electrodes.

7. The touch screen as set forth in claim 1, wherein the extending portions of the internal transparent electrodes extend between the external transparent electrodes.
